(19) United States
(12) Patent Application Publication
(10) Pub. No.: US 2016/0340841 A1
(43) Pub. Date: Nov. 24, 2016

(54) AUTOMATED ROTOR CONTROL OF AN ELECTRICALLY DRIVEN DRUM

(71) Applicant: CATERPILLAR PAVING PRODUCTS INC., BROOKLYN PARK, MN (US)

(72) Inventors: Andrew James Krolnik, Brooklyn Park, MN (US); Eric Steven Engelmann, Delano, MN (US); Nathan Louis Mashek, Saint Michael, MN (US)

(73) Assignee: CATERPILLAR PAVING PRODUCTS INC., BROOKLYN PARK, MN (US)

(21) Appl. No.: 14/715,301

(22) Filed: May 18, 2015

(51) Int. Cl. E01C 23/088; B60W 10/04; B60W 10/30; E01C 23/12

(52) U.S. Cl. CPC E01C 23/088; E01C 23/127; B60W 10/04; B60W 10/30; E01C 2301/00

(57) ABSTRACT

A work machine may include a rotary cutter having a rotational speed. An electric motor may be operatively engaged with the rotary cutter. A controller may be in communication with the electric motor and configured to adjust the rotational speed relative to a travel speed of the work machine.

### TECHNICAL FIELD

The present disclosure relates generally to milling drums for a work machine and, more particularly, to drive control of the milling drums for such a work machine.

### BACKGROUND

Some work machines in the construction industry implement a rotatable cutter such as a milling drum that is disposed on the underside of the work machine. As an example, a cold planer is one type of such a work machine. Cold planers generally remove layers or portions of a paved road surface in preparation for paving operations and, as such, include cutting teeth that are arranged on the milling drum to perform the cutting of the road surface. The removed road surface is then typically transferred via a conveyor for disposal or recycling. Another example of such a work machine is a road reclaimer, which may be known by other names such as, but not limited to, road recycler and soil stabilizer. In addition to cutting or pulverizing the road surface with a rotatable cutter, road reclaimers generally mix liquid additives with the reclaimed road surface material to create new, recycled road surfacing material for use in providing a stabilized road bed.

In particular, it is desirable for the rotatable cutter to leave behind a scored surface texture that is suitably uniform in nature to provide, in some cases, a relatively less rough surface that may be driven on before completion of the repaving process, and in other cases, a scored surface that facilitates adherence of a new road surfacing material thereto. It is conventionally known that the rotatable cutter may provide a uniform scored surface texture when the ratio of the ground speed of the work machine to the rotational speed of the rotatable cutter is maintained within an optimum range or ratio to each other. Operation of the work machine in which the ground speed or the rotational speed are not appropriately compensated for each other will typically result in a non-uniform grooved surface texture that may be wavy or rough such that the non-uniformed grooved surface may be unsuitable for traveling over and may adversely affect the adhering characteristics of the new road surfacing material to the non-uniformed grooved surface.

U.S. Pat. No. 8,465,105 (the '105 patent) discloses a control system for a cutter drum. In particular, an engine of the work vehicle is operatively engaged with the cutter drum via a transmission. The transmission includes an input shaft that is operatively engaged with the engine and an output shaft that is operatively engaged with the cutter drum such that the transmission may change the ratio of the rotational speed of the output shaft with respect to the rotational speed of the input shaft. While effective, the operatively mechanical linkage between the engine and the cutter drum limits controlling the ratio of the ground speed of the work vehicle to the cutter drum speed to be dependent upon maintaining the ratio between the speed of the engine output and the speed of the input to the cutter drum.

### SUMMARY

In accordance with an aspect of the disclosure, a work machine may include a rotary cutter having a first sensor of a plurality of sensors to determine a rotational speed of the rotary cutter. The work machine may also include a second sensor of the plurality of sensors to determine a travel speed of the work machine. An electric motor may be operatively engaged with the rotary cutter. A controller may be in communication with the electric motor, the first sensor of the plurality of sensors, and the second sensor of the plurality of sensors. The controller may be configured to receive the rotational speed of the rotary cutter and the travel speed of the work machine, to determine a target rotational speed for the rotary cutter based on the travel speed of the work machine, and to adjust the rotational speed of the rotary cutter to match the target rotational speed.

In accordance with another aspect of the disclosure, a work machine may include a plurality of ground engaging elements supporting a frame. The plurality of ground engaging elements may have a travel speed. A rotary cutter may be rotationally coupled to the frame. The rotary cutter may have a rotational speed. A rotor may be operatively engaged with the rotary cutter. A controller may be in communication with the rotor and configured to adjust the rotational speed so that a real-time ratio of the rotational speed to the travel speed meets a predetermined ratio of the rotational speed to the travel speed.

In accordance with yet another aspect of the disclosure, a method for monitoring and controlling a rotary cutter of a work machine is provided. The method entails driving an electric motor to rotate the rotary cutter. Another step may be sensing a rotational speed of the rotary cutter. Yet another step may be sensing a travel speed of the work machine. A further step may be controlling the electric motor to adjust the rotational speed of the rotary cutter so that a real-time ratio of the rotational speed to the travel speed of the work machine meets a predetermined ratio of the rotational speed to the travel speed.

### BRIEF DESCRIPTION OF THE DRAWINGS

FIG. 1 is a side view of an exemplary work machine, in accordance with the teachings of the present disclosure;

FIG. 2 is a schematic diagram illustrating an exemplary power train of the work machine depicted in FIG. 1, in accordance with the teachings of the present disclosure;

FIG. 3 is a schematic diagram illustrating an alternative exemplary power train of FIG. 2, in accordance with the teachings of the present disclosure; and

FIG. 4 is a flow chart illustrating a sample sequence of steps which may be practiced in accordance with the teaching of the present disclosure.

### DETAILED DESCRIPTION

The present disclosure provides systems and methods for controlling a ratio of a rotary cutter speed to a ground speed of a work machine, and vice versa, based on work machine operating parameters. Such systems and methods may provide an electric motor to automate the rotary cutter speed relative to the ground speed of the work machine.

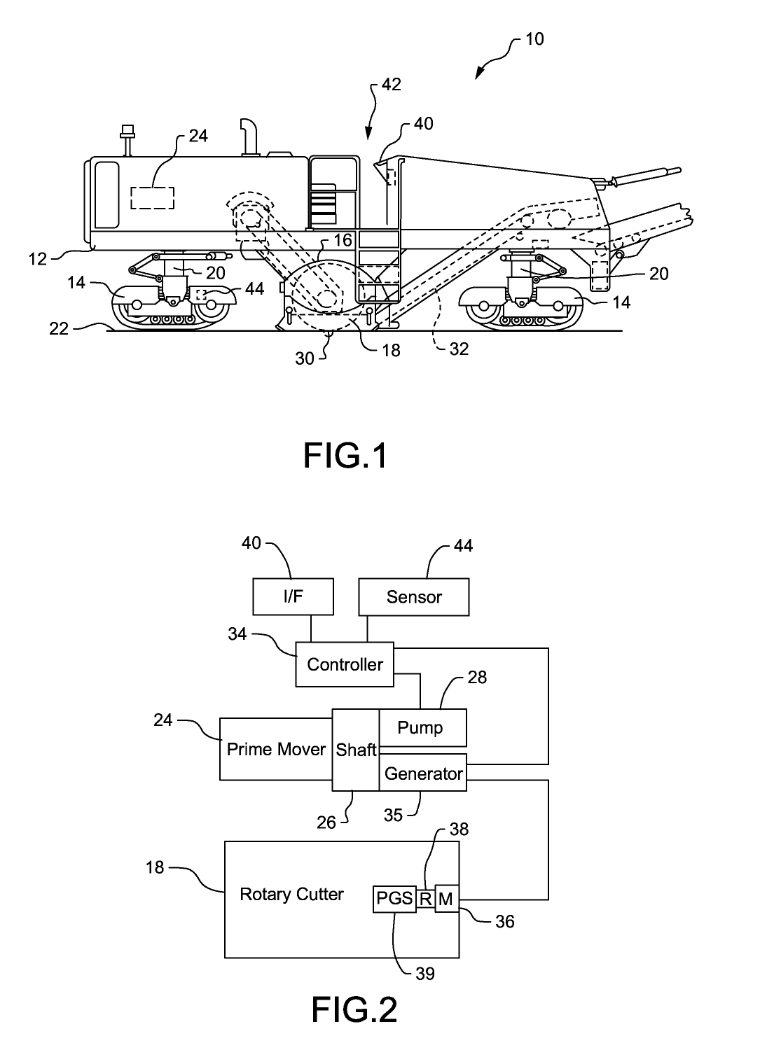

Referring now to FIG. 1, an exemplary work machine constructed in accordance with the present disclosure is generally referred to by reference numeral 10. The work machine 10 may be any type of work machine well known in the construction industry that is utilized in pavement removing operations such as, but not limited to, cold planers and road reclaimers or stabilizers. The work machine 10 may include a frame 12 that is supported by a plurality of ground engaging elements 14. As non-limiting examples, the plurality of ground engaging elements 14 may be tires or tracks. A housing 16 may be coupled to the underside of the work machine 10 such that a rotary cutter 18 may be rotatably coupled to the frame 12 within the housing 16. Moreover, each of the plurality of ground engaging elements 14 may be operatively engaged with the frame 12 via hydraulic cylinders 20. The hydraulic cylinders 20 may vertically adjust the elevation of the frame 12 with respect to a ground surface 22 so that the rotary cutter 18 may be raised away from, or lowered into engagement with, the ground surface 22.

With reference to both FIGS. 1 and 2, the frame 12 may support a prime mover 24, which supplies power to the plurality of ground engaging elements 14 for propelling the work machine 10. In an exemplary embodiment, the prime mover 24 may operatively engage a power take off shaft 26 to supply power to a hydraulic pump 28, which may form part of a hydrostatic transmission to drive the plurality of ground engaging elements 14. The prime mover 24 may be, but is not limited to, an internal combustion engine, a diesel engine, a natural gas engine, a hybrid engine, and any combination thereof.

The rotary cutter 18 may be, but is not limited to, a milling drum and may include a plurality of cutting tools 30 mounted thereon. Although only one cutting tool 30 is shown in FIG. 1, each cutting tool of the plurality of cutting tools 30 may be disposed on the rotary cutter 18 in various configurations to provide a desired cut pattern into the ground surface 22. As the rotary cutter 18 rotates, the plurality of cutting tools 30 may remove layers or portions of the ground surface 22 onto a conveyor 32.

A controller 34 may control the hydraulic pump 28, the prime mover 24, and an electric generator 35. The electric generator 35 may be operatively engaged with the power take off shaft 26. The electric generator 35 may convert the power supplied from the prime mover 24 via the power take off shaft 26 into electrical power and may supply the electrical power to an electric motor 36 of the rotary cutter 18. The electric motor 36 may include a rotor 38 that is operatively engaged with a planetary gear set 39, or other form of gear box. The planetary gear set 39 may be in operative engagement with the rotary cutter 18 to permit rotation of the rotary cutter 18 and to step up or step down the rotational speed as needed. The controller 34 may be in communication with an interface 40 that may receive command inputs from an operator of the work machine 10. The interface 40 may be located in an operator station 42 of the work machine 10 and may be, but is not limited to, a display interface. The controller 34 may also receive real-time operating conditions of the work machine 10 via a plurality of sensors 44. The plurality of sensors 44 may be disposed throughout the work machine 10 to monitor and determine real-time operating parameters of the work machine 10 such as, but not limited to, the prime mover speed, the travel speed of the work machine 10, the rotational speed of the rotary cutter 18, the rotational speed of the rotor 38, and wear on the plurality of cutting tools 30. The controller 34 may be any type of processor or microprocessor that is well known in the industry.

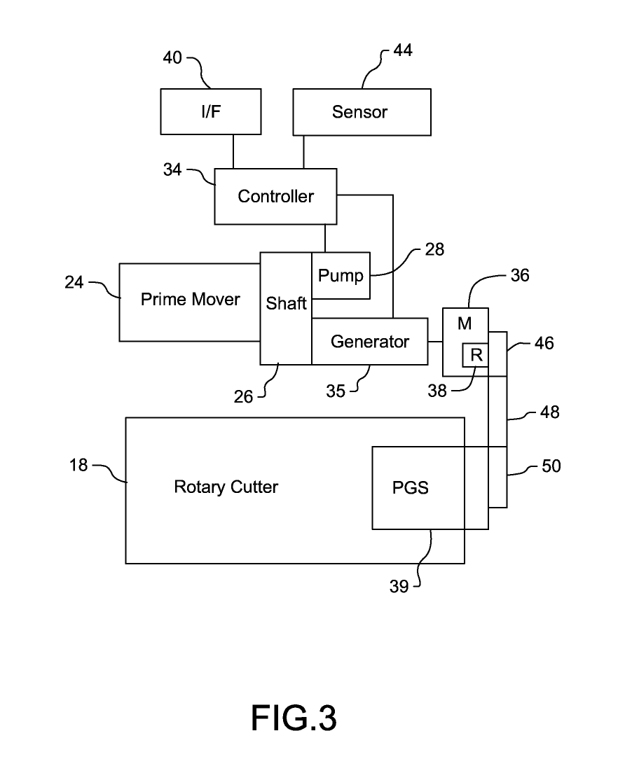

Referring to FIG. 3, an alternative exemplary embodiment of the operative engagement of the rotor 38 with the rotary cutter 18 is illustrated with like reference numerals depicting like parts of FIG. 2. As opposed to the embodiment of FIG. 2, with this alternative embodiment, the electric motor 36 may be disposed exteriorly of the rotary cutter 18. As a non-limiting example, in this embodiment, the electric motor 36 may be disposed on the frame 12. In particular, the rotor 38 may be operatively engaged with a rotor sheave, sprocket 46 or the like, which drives a v-belt or chain drive 48, respectively. The v-belt or chain drive 48 may be operatively engaged with a cutter sheave or sprocket 50, respectively. The cutter sheave or sprocket 50 may be operatively engaged with the planetary gear set 39, or other form of gear box, which is operatively engaged with the rotary cutter 18 so as to step up or down rotational speed as needed.

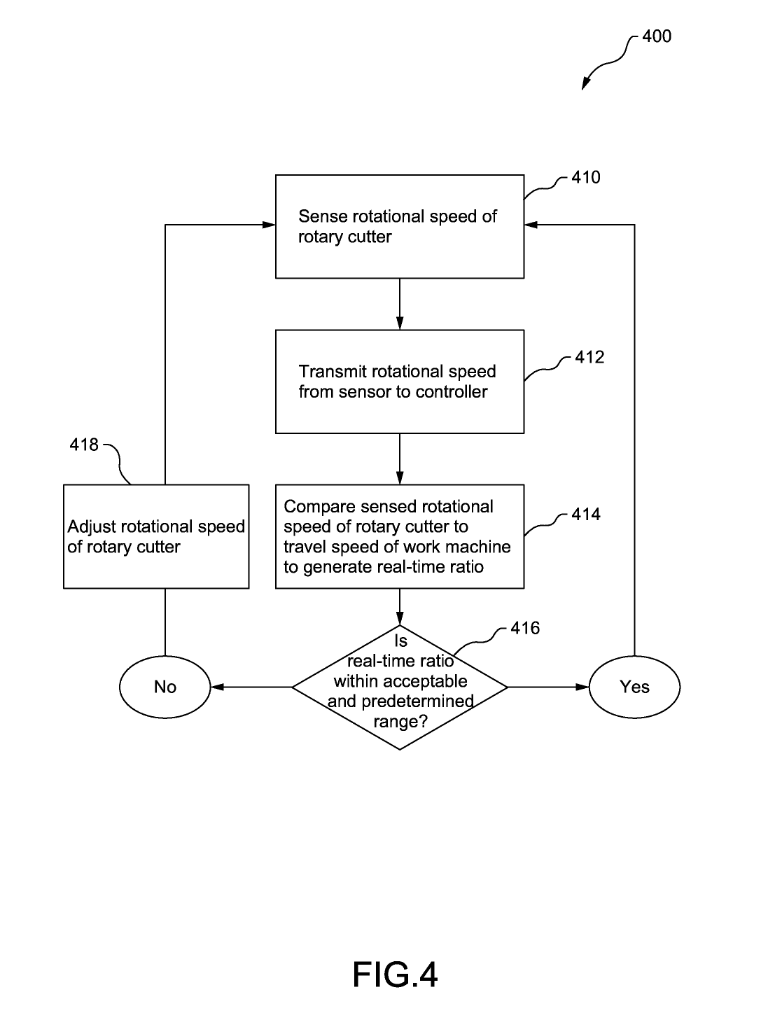

FIG. 4 illustrates a flowchart 400 of a sample sequence of steps which may be performed to control a rotary cutter of a work machine. Starting at box 410, the step of sensing the rotational speed of the rotary cutter 18 is shown. As illustrated in box 412, the rotational speed of the rotary cutter 18 may be transmitted from a sensor 44 to a controller 34. Another step, as depicted in box 414, may be comparing the sensed rotational speed of the rotary cutter 18 to the travel speed of the work machine 10 to generate a real-time ratio. At decision box 416, it is determined whether the real-time ratio meets a predetermined or target ratio, or range of ratios, of the rotational speed to the travel speed. If the real-time ratio meets this condition, then the step of sensing the rotational speed of the rotary cutter 18 is repeated. On the other hand, if the real-time ratio does not meet this condition, then the rotational speed of the rotary cutter 18 may be adjusted by controlling the electric motor 36 so that the real-time ratio of the rotational speed to the travel speed of the work machine 10 meets the predetermined ratio, or acceptable range of ratios, as illustrated by box 418. Alternatively, the speed of the work machine 10 may be governed so as to meet such a ratio, such as by pro-actively slowing prime mover RPM or providing a signal to the driver to slow the work machine speed. After the speed of the rotary cutter 18 has been adjusted, the step of sensing the rotational speed of the rotary cutter 18 is repeated. Another step may be sensing the travel speed of the work machine 10. A further step may be determining the real-time ratio by comparing, via a processor, a real-time rotational speed of the rotary cutter 18 and a real-time travel speed of the work machine 10. Yet another step may be monitoring the real-time rotational speed of the rotary cutter 18 and the real-time travel speed of the work machine 10. An even further step may be monitoring and comparing the real-time rotational speed of the rotary cutter 18 and the real-time travel speed of the work machine 10 at predetermined periodic intervals.

### INDUSTRIAL APPLICABILITY

Based on the foregoing, it can be seen that the present disclosure sets forth systems and methods for monitoring and controlling a rotary cutter of a work machine. In so doing, the quality of scored surface created by the work machine can be improved and uniformed more reliably. The teachings of this disclosure may be employed to adjust a rotational speed of the rotary cutter based on travel speed of the work machine to provide an optimal surface finish. Through the novel teachings set forth above, the work machine may consume less fuel due to the ability to operate the rotary cutter at increased speeds even while the prime mover operates at lower speeds. Moreover, unlike traditional systems and methods, the present disclosure eliminates a mechanical link between the prime mover and the rotary cutter.

In operation, the controller 34 monitors and coordinates control of the rotational speed of the rotary cutter 18 based on the travel speed of the work machine 10. As an example, the controller 34 may receive the speed of the rotary cutter 18 via one of the plurality of sensors 44 and may receive the travel speed of the work machine 10 via another one of the plurality of sensors 44. The controller 34 may compare the rotational speed of the rotary cutter 18 to the travel speed of the work machine 10 as a real-time ratio and determine whether the real-time ratio meets a predetermined ratio of the rotational speed of the rotary cutter 18 to the travel speed of the work machine 10. If the controller 34 determines that the real-time ratio does not meet the predetermined ratio, then the controller automatically adjusts the rotational speed of the rotary cutter 18, via the rotor 38 of the electric motor 36, such that the rotational speed of the rotary cutter 18 relative to the travel speed of the work machine 10 meets the predetermined ratio. The rotational speed of the rotary cutter 18 and the travel speed of the work machine 10 may be monitored and compared at predetermined periodic intervals during operation so that the rotational speed of the rotary cutter 18 may be automatically adjusted accordingly to meet the predetermined ratio. In this manner, the real-time ratio may be quickly adjusted to meet the predetermined ratio so that the rotary cutter 18 provides a uniform scored surface texture. Moreover, the controller 34 may receive and determine the wear on the plurality of cutting tools 30 and determine a target rotational speed for the rotor based on the travel speed of the work machine 10 and the wear on the plurality of cutting tools 30.

What is claimed is:

1. A work machine, the work machine comprising:
a rotary cutter having a first sensor of a plurality of sensors to determine a rotational speed of the rotary cutter;
a second sensor of the plurality of sensors to determine a travel speed of the work machine;
an electric motor operatively engaged with the rotary cutter; and
a controller in communication with the electric motor, the first sensor of the plurality of sensors, and the second sensor of the plurality of sensors, the controller configured to receive the rotational speed of the rotary cutter and the travel speed of the work machine, the controller configured to determine a target rotational speed for the rotary cutter based on the travel speed of the work machine, the controller configured to adjust the rotational speed of the rotary cutter to match the target rotational speed.

2. The work machine of claim 1, wherein the work machine is one of a cold planer and a road reclaimer.

3. The work machine of claim 1, wherein the controller is a processor.

4. The work machine of claim 1, further includes a plurality of cutting tools mounted on the rotary cutter and a third sensor of the plurality of sensors to determine wear on the plurality of cutting tools, the controller configured to determine the target rotational speed for the rotary cutter based on the wear on the plurality of cutting tools and the travel speed of the work machine.

5. The work machine of claim 1, wherein the controller is configured to monitor the rotational speed and the travel speed of the work machine as a real-time ratio.

6. The work machine of claim 5, wherein the controller is configured to compare the real-time ratio to a predetermined ratio of the rotational speed to the travel speed of the work machine.

7. The work machine of claim 5, wherein the controller is configured to monitor the rotational speed and the travel speed of the work machine at predetermined periodic intervals.

8. The work machine of claim 6, wherein the controller is configured to adjust the rotational speed so that the real-time ratio meets the predetermined ratio.

9. A work machine, the machine comprising:
a frame;
a plurality of ground engaging elements supporting the frame, the plurality of ground engaging elements having a travel speed;
a rotary cutter rotationally coupled to the frame, the rotary cutter having a rotational speed;
a rotor operatively engaged with the rotary cutter; and
a controller in communication with the rotor, the controller configured to adjust the rotational speed so that a real-time ratio of the rotational speed to the travel speed meets a predetermined ratio of the rotational speed to the travel speed.

10. The work machine of claim 9, wherein the rotor is operatively engaged with a rotor sprocket, the rotor sprocket operatively engaged with a cutter sprocket via a chain drive, the cutter sprocket operatively engaged with the rotary cutter via a planetary gear set.

11. The work machine of claim 9, wherein the rotary cutter is a milling drum.

12. The work machine of claim 9, further including a plurality of sensors, one sensor of the plurality of sensors in operative association with the rotor to monitor the rotational speed and another sensor of the plurality of sensors in operative association with the plurality of ground engaging elements to monitor the travel speed.

13. The work machine of claim 9, wherein the rotor is driven via an electric motor.

14. The work machine of claim 12, wherein the controller is configured to receive real-time rotational speed and travel speed from the plurality of sensors.

15. The work machine of claim 14, wherein the controller is configured to receive the real-time rotational speed and travel speed at predetermined periodic intervals.

16. The work machine of claim 14, wherein the controller is configured to determine the real-time ratio based on the real-time rotational speed and travel speed.

17. A method for controlling a rotary cutter of a work machine, the method comprising:
driving an electric motor to rotate the rotary cutter;
sensing a rotational speed of the rotary cutter;
sensing a travel speed of the work machine; and
controlling the electric motor to adjust the rotational speed of the rotary cutter so that a real-time ratio of the rotational speed to the travel speed of the work machine meets a predetermined ratio of the rotational speed to the travel speed.

18. The method of claim 17, further including the step of determining the real-time ratio by comparing, using a processor, a real-time rotational speed of the rotary cutter and a real-time travel speed of the work machine.

19. The method of claim 18, further including the step of monitoring the real-time rotational speed of the rotary cutter and the real-time travel speed of the work machine.

20. The method of claim 19, further including the step of monitoring and comparing the real-time rotational speed of the rotary cutter and the real-time travel speed of the work machine at predetermined periodic intervals.
